(19) United States
(12) Patent Application Publication
(10) Pub. No.: US 2022/0167697 A1
(43) Pub. Date: Jun. 2, 2022

(54) Disposable Barrier Glove and Method for Manufacturing the Barrier Glove

(71) Applicant: Protective Industrial Products, Inc., Latham, NY (US)

(72) Inventors: Jeffrey Donald Cohen, Mooresville, NC (US); Joseph Anthony Milot, III, Albany, NY (US)

(21) Appl. No.: 17/536,736

(22) Filed: Nov. 29, 2021

Related U.S. Application Data
(60) Provisional application No. 63/119,080, filed on Nov. 30, 2020.

(51) Int. Cl. A41D 19/00; B29C 41/14

(52) U.S. Cl. CPC A41D 19/0065; A41D 19/001; B29L 2031/4864; A41D 2500/54; B29C 41/14

(57) ABSTRACT

Disclosed is a flexible barrier glove manufactured by coating a glove liner with a mixture that includes polyurethane resin and an antibacterial agent.

### RELATED APPLICATION

This application claims priority to and the benefit of the filing date of U.S. Patent Application No. 63/119,080 filed Nov. 30, 2020 at Attorney Docket No. 1-2815-P and titled DISPOSABLE BARRIER GLOVE AND METHOD FOR MANUFACTURING THE BARRIER GLOVE, the '080 priority application pending on the filing date of the this application and incorporated by reference as if fully set forth herein.

### FIELD OF THE DISCLOSURE

The disclosure relates generally to disposable barrier gloves and a method for manufacturing disposable barrier gloves.

### BACKGROUND OF THE DISCLOSURE

Barrier gloves provide front-line medical and surgical personnel with protection from viruses and bacteria. A barrier glove presents a barrier resisting the transmission of viruses and bacteria through the thickness of the glove.

Because of the Covid-19 global pandemic, an extremely large worldwide spike in demand for the various types/versions of disposables gloves made of nitrile, latex, vinyl, polyvinyl chloride (PVC) and the like is being experienced. Such disposable gloves have been touted as barrier protection against the Covid-19 virus for both front line workers and the general public.

But there is a need for an improved disposable glove that is flexible yet still functions as a leak proof barrier glove that meets and preferably exceed recognized standards for viral and bacterial penetration and cut resistance.

### SUMMARY OF THE DISCLOSURE

Disclosed is a disposable glove that is flexible and functions as a barrier glove that meets recognized standards for viral and bacterial penetration, cut resistance, and etc.

Such recognized standards currently include:

EN455 and parts therein—Medical Gloves for Single Use;

ANSI/ISEA 105-2016 Hand Protection Classification;

ISO 20743:2013 Textiles—Determination of antibacterial activity of textile products; and

EN ISO 374:2016 and parts 1-4 therein: Protective gloves against dangerous chemicals and micro-organisms.

An embodiment of the disclosed glove has a glove liner that is coated with polyurethane. The polyurethane includes an antibacterial agent.

A method of manufacturing the disclosed glove includes the steps of reducing the viscosity of a liquid polyurethane resin; adding an antibacterial agent to the reduced-viscosity liquid polyurethane resin; coating a glove liner with the polyurethane resin with the antibacterial agent; and allowing the polyurethane resin to cure on the glove liner.

The glove liner in possible embodiments is a knitted glove liner or knitted glove knitted from a polyester yarn, a nylon yarn, or other yarn that satisfactorily adheres to the cured polyurethane and provides satisfactory flexibility in the finished glove. The nylon knitted glove liner in a non-limiting embodiment is a thin 18GA nylon liner or a thin 18GA engineered yarn liner that provides A3 cut protection per ANSI/ISEA 105-2016 (ASTM F2992-15 test method).

The step of reducing the viscosity of the liquid polyurethane resin can include the step of shearing the resin with a high-shear mixer. The resulting viscosity of the resin in a non-limiting embodiment may be between 500 poise and 600 poise.

The step of adding the antibacterial agent can include adding the antibacterial agent at a rate of between 0.1%-10% weight percent or volume percent of the polyurethane resin or of the entire mixture. The antibacterial agent may be provided in a solvent.

The step of adding the antibacterial agent can include the step of stirring/shearing the polyurethane resin after adding the antibacterial agent.

The method can further include prior to coating the glove liner the step of adding an additive or additives to the polyurethane resin/antibacterial agent mixture to make a cross-linking and bonding reaction with the sheared resin prior to coating the glove liner. The mixture may rest for a time (for a non-limiting example, between 6 hours and 12 hours) to allow the cross-linking and bonding reaction to proceed in the mixture.

The step of coating the glove liner may include placing the glove liner on a hand former, dipping the glove liner on the hand former into a tank containing the polyurethane resin/antibacterial agent mixture to coat and/or saturate the glove liner with the mixture to form a coated glove liner. The coated glove liner can then be cured in an oven, washed, and then dried.

Rather than immersing the glove liner in a tank, the step of coating the glove liner may alternatively include coating the glove liner using rollers applied to the glove liner that coat and/or saturate the glove with the mixture.

Other objects and features of the disclosure will become apparent as the description proceeds, especially when taken in conjunction with the accompanying drawing sheet.

### BRIEF DESCRIPTION OF THE DRAWING

FIG. 1 is the sole application drawing and illustrates the steps of an embodiment of a method for manufacturing a flexible barrier glove in accordance with this disclosure.

### DETAILED DESCRIPTION

For background, Sha U.S. Pat. No. 8,241,705 incorporated by reference as if fully set forth herein discloses a method for manufacturing polyurethane coated gloves.

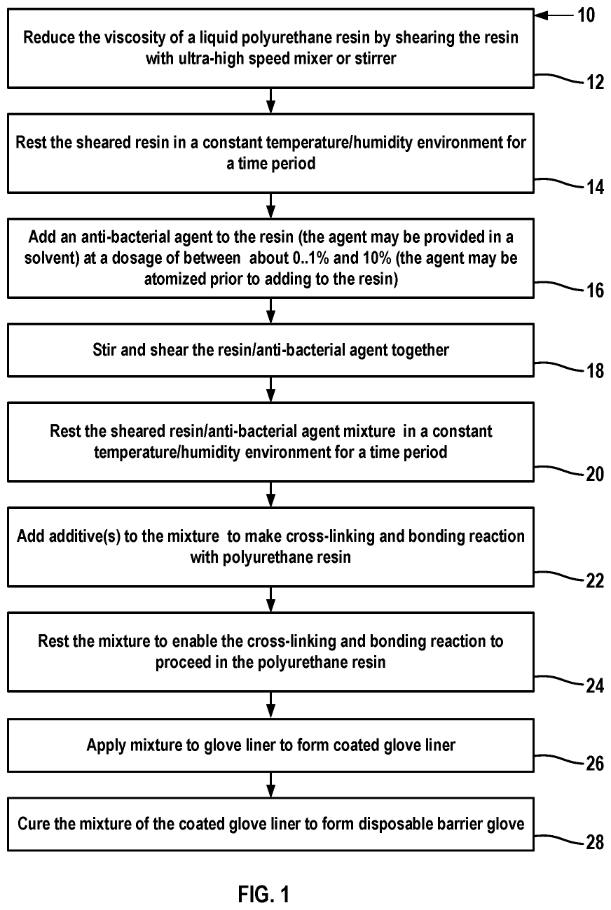

The steps of a method 10 in accordance with this disclosure for coating a glove liner with a polyurethane mixture to form the applicant's X-389™ flexible barrier glove in accordance with this disclosure is shown in FIG. 1.

Steps 12-24 illustrate the steps of making a polyurethane-based resin coating mixture.

Starting with a quantity of polyurethane resin, it is desired to quickly reduce the viscosity of the resin. In step 12, the viscosity of the resin is reduced, by, for a non-limiting example, shearing the resin using an ultra-high speed mixer or stirrer. It is theorized the mixing or stirring the resin at high speed shears the resin's polymer chains, altering the resin's molecular structure and thereby quickly reducing the viscosity of the resin.

The resulting viscosity of the resin in a non-limiting embodiment may be between 500 poise and 600 poise after performing step 12.

Rest the sheared resin in a constant temperature/humidity environment, step 14.

Add an antibacterial agent to the rested resin in the next step 16. Atomize the antibacterial agent and place in the resin. The antibacterial agent may be provided in a solvent. The antibacterial agent may be provided at a rate of between 0.1% -10% weight percent or volume percent of the polyurethane resin or of the entire mixture, depending on the production quantity.

After adding the antibacterial agent, stir and shear the resin and antibacterial agent together at high speed, step 18.

Rest the resin/antibacterial agent mixture after stirring in a constant temperature/humidity environment, step 20.

Next add an additive or additives to the resin mixture that make cross-linking and bonding reactions with the sheared resin, step 22. The additive or additives may be atomized prior to mixing.

Rest the resin mixture with the cross-linking additives, step 24. The resin mixture can be rested in a constant temperature/humidity environment for about 6-12 hours, depending on the type of additive(s) added to the resin. This enables the resin to cross-link and recombine as a new polymer structure incorporating the antibacterial agent.

Steps 26 and 28 illustrate the steps of using the resin coating mixture created at the end of step 24 with a glove liner to form the flexible barrier glove. The glove liner in possible embodiments is a knitted glove liner or knitted glove knitted from a polyester yarn, a nylon yarn, or other yarn that satisfactorily adheres to the cured polyurethane and provides satisfactory flexibility in the finished glove. The nylon knitted glove liner in the illustrated embodiment is a thin 18GA nylon liner or a thin 18GA engineered yarn liner that provides A3 cut protection per ANSI/ISEA 105-2016 (ASTM F2992-15 test method).

In step 26, the resin mixture is applied to the glove liner to coat the glove liner and form a coated glove liner. The step can be applied along a production line to efficiently coat many gloves with the resin mixture.

The step 26 of coating the glove liner may include placing the glove liner on a hand former, dipping the glove liner on the hand former into a tank containing the polyurethane resin/antibacterial agent mixture to coat and/or saturate the glove liner with the mixture to form a coated glove liner. In step 28, the coated glove liner is then be cured in an oven. The cured coated glove is then be washed and dried.

Rather than immersing the glove liner in a tank, the step 26 of coating the glove liner may alternatively include coating the glove liner using rollers applied to the glove liner that coat and/or saturate the glove with the resin mixture.

After coating the glove liner with the polyurethane mixture, the coated glove liner is allowed to cure and form the flexible barrier glove.

With the increasing maturity of industrial automation and the wide use of smart phones, the ability to use touch screens with gloves has become very important. The inherently low surface resistance of the disclosed polyurethane-coated flexible barrier glove enables a user wearing the glove to use a touch screen while wearing the glove.

If the surface resistance of a production run of the flexible barrier glove manufactured in accordance with this disclosure is too high to assure reliable touch screen operation by a user wearing the glove, a conductive agent can be added to the polyurethane mixture applied to the glove liner to reduce the resulting surface resistance of the barrier glove.

Attributes and benefits of the disclosed barrier glove are:
fully coated glove (palm, finger & back of hand) with polyurethane coating;
liquid proof—passed EN374-2;
air leak tested—passed EN374-2;
barrier protection against blood borne pathogens—passed EN374-5;
barrier protection for E-Coli, Staph, Candida albacians and H1N1—passed per ISO 20743:2013 test method and EN374-5;
AQL (acceptable quality limit) - Same AQL as industrial grade disposable gloves;
touchscreen capability through the polyurethane coating;
silicone free; and
the glove can be laundered typically up to 6 times and maintain the same performance.

Based on the above attributes, the disclosed barrier gloves can provide the same barrier protection and AQL rating as industrial grade disposables, but with the added benefits of better grip, touchscreen, antimicrobial/antiviral properties and reusability.

While this disclosure includes one or more illustrative embodiments described in detail, it is understood that the one or more embodiments are each capable of modification and that the scope of this disclosure is not limited to the precise details set forth herein but include such modifications that would be obvious to a person of ordinary skill in the relevant art including (but not limited to) changes in material selection, size, operating ranges, environment of use, incorporation of additional additive types in the polyurethane mixture, and the like, as well as such changes and alterations that fall within the purview of the following claims.

What is claimed is:

1. A method for manufacturing a polyurethane coated glove comprising the steps of:
(a) coating a glove liner with a mixture comprising a polyurethane resin and an antibacterial agent; and
(b) curing the coated glove liner to form a polyurethane coated glove.

2. A method for manufacturing a polyurethane coated glove comprising the steps of:
(a) adding an antibacterial agent to a liquid polyurethane resin to form a mixture comprising said agent and said resin;
(b) coating a glove liner with the mixture to form a coated glove liner; and
(c) curing the polyurethane resin of the coated glove liner.

3. The method of claim 2 wherein the antibacterial agent added in step (a) is present in the mixture at between 0.1% and 10% weight percent or volume percent of the mixture.

4. The method of claim 2 comprising the step of reducing the viscosity of the polyurethane resin prior to adding the antibacterial agent.

5. The method of claim 2 comprising the step of cross-linking the polyurethane resin after performing step (b).

6. The method of claim 2 wherein step (b) comprises dipping the glove liner into a tank holding the mixture.

7. The method of claim 2 wherein step (b) comprises applying a roller to the glove liner, the roller transferring the mixture to the glove liner.

8. The method of claim 2 wherein the glove liner is a knitted glove liner.

9. The method of claim 8 wherein the glove liner is knitted from a polyester yarn or a nylon yarn.

10. A polyurethane coated glove comprising a glove liner and a polyurethane coating the glove liner, the polyurethane comprising an antibacterial agent dispersed throughout the polyurethane coating.

11. The glove of claim 10 wherein the polyurethane coating coats the entire outside of the glove.

12. The glove of claim 10 being leak proof per EN374-2.

13. The glove of claim 10 providing barrier protection against blood borne pathogens per EN374-5

14. The glove of claim 10 having no air leaks per EN374-2.

15. The glove of claim 10 providing barrier protection for E-Coli, Staph, Candida albacians and H1N1 per ISO 20743:2013.

16. The glove of claim 10 providing barrier protection for E-Coli, Staph, Candida albacians and H1N1 per EN374-5.

17. The glove of claim 10 wherein the glove liner is a knitted glove liner.

18. The glove of claim 17 wherein the glove liner is knitted from a polyester yarn or a nylon yarn.
